(19) United States
(12) Patent Application Publication
(10) Pub. No.: US 2009/0117461 A1
(43) Pub. Date: May 7, 2009

(54) Electrode for lithium primary and secondary (rechargeable) batteries and the method of its production

(75) Inventors: Elena M. Shembel, Coral Springs, FL (US); Nataliya Globa, Dnipropetrovsk (UA); Andrey Ryabchuk, Novorossyisk (RU)

Correspondence Address: Enerize Corporation, 4956 Rothschild Dr, Coral Springs, FL, 33067-4134, US

(73) Assignee: Enerize Corporation, Coral Springs, FL (US)

(21) Appl. No.: 12/290,068

(22) Filed: Oct. 27, 2008

(30) Foreign Application Priority Data
Apr. 27, 2006 (UA) A 2006 04674
Oct. 11, 2006 (UA) PCT/UA2006/000055

(51) Int. Cl. H01M 4/02; H01M 4/58; H01M 4/04; H01M 4/60; H01M 4/62; B05D 5/12

(52) U.S. Cl. 429/217; 429/209; 429/218.1; 429/231.95; 429/231.7; 429/231.8; 429/212; 427/77; 361/500

(57) ABSTRACT

The present invention relates to a method for production of electrodes for Li-primary and Li-ion batteries based of using two types of binder. The first binder is soluble in organic solvent and second binder is insoluble in organic solvent during the process of slurry preparation. Combination of the slurry composition and conditions of the electrode temperature treatment decrease the cathode production complexity, improve electrochemical characteristics of the electrode, increase adhesion properties and flexibility of coating, and reduce the interface resistance between the current collector and electrode mass.

### CROSS-REFERENCE TO RELATED APPLICATIONS

None

### FEDERALLY SPONSORED RESEARCH

None

### SEQUENCE LISTING

None

### REFERENCE DOCUMENTS

Ukrainian Patent Application # a 2006 04674, priority date of Apr. 27, 2006

PCT Application PCT/UA2006/000055, Int. filing date of Oct. 11, 2006

### FIELD OF THE INVENTION

The present invention relates to electrodes for technologies of the lithium primary and secondary batteries and supercapacitors, and specifically to electrodes for such chemical power sources that use non-aqueous electrolytes.

### BACKGROUND OF THE INVENTION

Lithium and lithium-ion batteries are widely used in the various applications where energy storage and off grid power are required. Use of for such power sources continues to expand. The increasing number of variety of devices that use such power sources have also extended the requirements for operating temperature range, power, discharge energy, and discharge rate for primary batteries and the charge/discharge rate for secondary batteries and super capacitors.

Compounds such as MnO₂, FeS₂, TiS₂, MoO₃, CFₓ and others are widely used as cathode materials for primary lithium batteries, wherein Li-metal or Li—Al alloy is the active anode material. As a rule, these are used in primary batteries. Oxide compounds such as LiCoO₂, LiNiO₂, LiCo₁₋ₓNixO₂, the spinel form of LiMn₂O₄ and others are usually used as active cathode materials for secondary lithium batteries. Graphite or other materials that can be intercalated with lithium are often used as the active anode materials for Li-ion batteries.

The electrode compositions contain the active materials, conductive additives and binder. Conductive additives enhance electron conductivity of the electrode materials. The binder is responsible for the mechanical durability of the coating materials, and for its flexibility and adhesion to a current collector. Graphite, carbon black, and other materials based on carbon are used as the conductive additives. Polymer materials such as PVDF, Teflon® and others are used for binders. The binders generate the structure that provides the link between the powder particles of active material and the electrically conductive additives.

Technologies for electrode production for lithium and lithium-ion batteries can be divided into two groups:

1. The first group includes the binders that do not dissolve in the organic solvents. In this case lamination of a rubber-like mass on the current collector is used. The lamination is followed by the thermal treatment. Under thermal treatment a partial melt of the binder occurs. The result is cohesion between particles of the active materials and conductive materials. The current collector can be in the form of a foil or a grid.

2. The second group of the technologies for electrode fabrication uses binders that are soluble in organic solvents. Initially, a slurry is formed. This slurry includes a solution of the binder in the organic solvent, powders of active components and conductive additives. The slurry is coated onto the current collector, followed by drying and calendaring (compacting). The current collector can be in the form of foil or grid.

More detailed descriptions regarding these two approaches are provided below.

For the first group of electrodes, a tetrafluoroethylene resin (hereinafter referred to as PTFE) in the form of powder or aqueous suspension is used. The particular property of this type of the suspension is the high level of PTFE fibrillation. The electrode mass produced by this method way is quite rigid. Therefore this mass is applied to a current collector by lamination. This method for electrode production was historically used in the batteries with alkaline electrolyte. At present, this technology is mainly utilized for production of coin-cells, as well as prismatic and cylindrical batteries based on MnO₂ Water, ethyl alcohol or isopropanol is a dispersion medium used in this technology. Various thickeners and stabilizers are also used for preparing the electrode mass.

The authors of U.S. Pat. No. 5,543,249 used surface active materials from the polyglycol group for stabilization of the PTFE -based suspension. The high level of PTFE fibrillation makes it difficult to obtain a homogeneous cathode mass and thus additional homogenization is necessary.

For regulation of fiber formation, the authors of U.S. Pat. No. 5,707,763 propose a combined binder, wherein particles consist of a nucleus of fibrillating PTFE and a shell of the non-fibrillating polymer. A disadvantage of this technology is the difficulty in producing a thin coating due to poor adhesion of the PTFE. Another disadvantage is the incompatibility of some of the active cathode materials with water and stabilizers.

Polyvinylidene fluoride (PVDF) homopolymer or polyvinylidene fluoride hexafluoropropylene (PVDF/HFP) copolymer are used in the second group of electrode production technologies. These polymers are dissolved into such solvents as N-methyl-2-pyrrolidone, acetone, dimethylformamide, or dimethylacetoamide. The mixture of active materials and conductive additives is introduced into a polymer solution and a slurry is prepared by mixing and homogenization. Then the slurry is applied by extrusion to the current collector that is in the form of a foil or grid. Thereafter, the coating is dried and compressed prior to final electrode production for lithium or lithium ion batteries.

Special coating machines are used for this technology. These machines exhibit higher productivity in comparison with lamination technology and maintain uniform thickness for electrodes with coating width of up to 20 centimeters with practically no limits with regard to thickness.

In spite of the fact that fluorine polymers of PVDF-group have better adhesion capability, the problems with adhesion and flexibility still occur as in the first and second technologies described so far. Moreover, there is a risk of PVDF/HFP-copolymers swelling in the electrolyte of the batteries that can lead to change in the electrode microstructure.

Attempts to solve these problems are mainly connected with binder modification and plasticizer utilization (U.S. Pat. No. 6,265,107; U.S. Pat. No. 6,001,507; U.S. Pat. No. 5,961,671). PVDF-based electrode production (the second technology) is the most advanced in comparison with the PVDF-based cathode mass lamination technology. Therefore, the appearance of a new polymer-solvent system with the object of adapting the materials used for lamination technology to extrusion technology is quite natural.

A search for new polymer-solvent systems for MnO₂-cathodes was described in US Patent Application #20040091773. The authors proposed linear triblock styrene-ethylene-butylene copolymer cross-linked by melamine formaldehyde resin, EPDM-caoutchouc-riblock fluorocarbon polymers, hydro-nitryle caoutchouc, PVDF copolymers, thermoplastic polyurethanes and olefins, as binders. Normal and branched hydrocarbons, cyclic paraffinic solvents and aromatic hydrocarbons were used as solvents. The authors underlined the compatibility of this cathode production technology with traditional methods for the lithium-ion system based on PVDF. The traditional methods consist of preparing a cathode composition slurry based on binder-solvent solution and coating it on a current collector followed by drying. Although the authors covered a wide class of polymers and solvents, they did not notice their compatibility with MnO₂. Correspondingly, electrochemical properties of cathodes and batteries were not disclosed. As a results, the practical value of this invention was not disclosed, and not confirmed.

Other binder-solvent systems have been proposed. These utilize similar technology to that based on PVDF. For example, application of latex binder based on a carboxylated styrene-butadiene copolymer and styrene-acrylate copolymer (U.S. Pat. No. 6,399,246), and acrylonitrile-butadiene rubber with carboxymethylcellulose (U.S. Pat. No. 6,183,907) were described for non-aqueous electrolyte systems. Water was the dispersion medium in both cases. As pH of latex emulsion is about 8-10, it is not always acceptable for some active cathode materials due to chemical decomposition if the active materials and the resulting decrease in the electrochemical activity of the electrodes.

The goal of the present invention is to develop highly efficient electrodes for Li-ion batteries and Li-primary batteries with non-aqueous electrolyte based on new technology using PVDF for production of the electrodes. Specifically, the goal is to develop electrodes with improved mechanical and electrochemical properties. Among these electrodes are cathodes based on such materials as LiCoO₂, LiNiO₂, LiCo₁₋ₓNₓO₂, LiMn₂O₄ for Li-ion batteries. The additional objecti

that are based on such active materials as MnO₂, FeS₂, TiS₂, MoO₃, or CFₓ. Lamination technology is traditionally used for these types of electrodes.

### SUMMARY OF THE INVENTION

An objective of the present invention is to develop electrodes with high efficiency, as well as a wide operating temperature range, high power, high discharge energy, high discharge rate for primary batteries, and a high charge/discharge rate for secondary batteries and super capacitors.

This objective of the present invention is achieved by using two types of the binders in the electrode mass composition that includes the active material and electrically conductive additive.

One of these binders is soluble in organic solvent during preparation of the electro-active composition slurry. The other binder is a powder that is insoluble in organic solvent. This binder is mixed with the dry powder that constitutes the active electrode mass and dry conductive additives.

The electrode is comprised of the following components:
current collector that can be a metallic foil or grid;
active electrode material that is a composition of oxides, sulphides, oxides intercalated by lithium, metal-complexes, spinels, fluorinated carbon or carbon-based compounds;
conductive additive with electron conductivity that ranges from 5% to 7% of the total mass of the electrochemically active composition. Such conductive additives might include:
   blend of carbon black and graphite in the ratio from 2:1 to 1:1 by mass;
   carbon material produced from graphitized carbon black with specific surface area ranging from 40 m²/g to 70 m²/g and particle size up to 3 microns comprising 50% of the conductive materials;
the binder that soluble in organic solvent during preparation of electrochemically active composition slurry is a PVDF class compound wherein:
   the binder class is a PVDF copolymer with molecular weight of at least 3×10⁵ g/mol;
   the binder is a PVDF homopolymer with the molecular weight of at least 3×10⁵ g/mol;
for the dissolution of the for PVDF binder, an aprotonic organic solvent could be used;
the binder that is insoluble in organic solvent during preparation of electrochemical active composition slurry is a PTFE compound wherein:
   the PTFE binder used is a powder with the of particle size from 0.2 to 4 microns;
   the PTFE binder is introduced into the composition of dry components (active materials powder and conductive additive powders) during the initial mixing process;
the mass ratio of PVDF to PTFE ranges from 1.2 to 1.7 in the content of electrochemically active composition;
the dispersion medium for the dissolution of the PVDF during the process of slurry preparation in the appropriate solvent is selected from the group: N-methyl-2-pyrrolidone, acetone, dimethylformamide, dimethylacetoamide (mainly dimethylacetoamide);
the mixture of active electrode material, conductive additives and the PTFE binder is a continuous phase.

The method of the present invention for electrode production of electrodes for primary and secondary lithium batteries is comprised of the following steps:
preparing the blend of PVDF type components in a suitable combination of solvents;
homogenization of the solid-phase components including powders of the active materials, the conductive additive powders, and the PTFE type binder.
mixing and homogenization of the solid materials with solutions of the PVDF in organic solvents;
slurry degassing;
applying the slurry to the metal current collector;
drying of the coating;
compression by calendaring;
removal of residual water and solvent.

These process steps are described in more detail below.

Preparation of the mixture of solid phase components of the electrochemically active composition includes mixing the active material powders and conductive additives with the electron conducting powder and the PTFE binder powder using a ball mill.

Preparation of the binder solution includes dissolving the selected PVDF polymer into an appropriate solvent selected from the group of N-methyl-2-pyrrolidone, acetone, dimethylformamide, dimethylacetoamide (mainly dimethylacetoamide) with intermediate heating up to 60° C. using paddle type disperser.

The blend of solid phase components is introduced into the solution of soluble binder by 10% to 15% portions of the total amount of dry components using low-speed mixer with anchor or Z-type paddles.

An alternative method of introducing the solution of the soluble binder into the blend of the solid phase components is with continuous mixing using low-speed mixer anchor or Z-type paddles.

The product of the combination of the solid phase of the component blend and the solution of the soluble binder is subjected to homogenization using a high-shear mixer with speed changing from 1500 up to 8000 rpm during 30-45 minutes with cooling.

The homogenized slurry of the electrochemically active composition is subjected to degassing by vacuum while continuously mixing using a low-speed mixer anchor or Z-type paddles. The amount of solid phase components in the slurry is 30-60% by mass.

The slurry viscosity ranges from 5000 up to 12000 cp at 23° C., measured by Brookfield DV III, 20 rpm, spindle #31.

The slurry of electrochemically active composition is applied to the current collector by extrusion.

The electrochemically active composition is dried immediately after coating onto the current collector by gradually increasing the temperature from 80° C. up to 120° C. Solvent vapors are removed by purging with hot air.

After drying the electrochemically active composition that is coated onto the metal current collector, it is compressed by calendaring, gradually decreasing the thickness. As a result, the total reduction in thickness is approximately 20-25%. As compared with initial electrode mass density, the electrode mass density increases by 30-45%. The porosity of the electrode mass is 20-40%.

The cut-to-cell dimensions electrode is dried at 125° C.-170° C. in air with continuous gas re-cycling a system that removes residual moisture and organic solvent vapor.

The cut-to-cell dimensions electrode is then dried at 125° C.-170° C. under inert gas that is re-circulated through a system that removes residual moisture and organic solvent vapor.

The cut-to-cell dimensions electrodes is then dried at 125° C. to 170° C. under vacuum.

The method of electrode production according present invention provides the following advantages:
decrease in complexity of cathode manufacturing
extension of the operating range of the parameters for active cathode materials applications;
improvement in the electrochemical properties of the cathode, and specifically, to extension of the operating temperature range from −40° C. up to +70° C. and an increase of discharge current up to 12-20 mA/cm²;
improved coating adhesion properties and electrode flexibility, as well as improved contact between current collector and electrode material resulting in decreased interface resistance between the current collector and the electrode mass.

Moreover, this technical solution according to the present invention allows production of thin flexible electrodes with coating on one or both sides of the current collector made of foil or grid (preferably aluminum). Made in this way cathodes can be utilized at prismatic or spiral wound cells without cracking of the coating.

The flexibility of coating allows spiral winding around a 3 mm rod without any cracking or peeling from the current collector. It is possible to produce coatings with electrode mass density ranging from 1 mg/cm² to 45 mg/cm².

The stated advances are achieved by use of:
high-molecular PVDF or PVDF/HFP;
dimethylacetoamide as the organic solvent for PVDF or PVDF/HFP;
PTFE powder as a second binder that is insoluble in organic solvent and acts as a plasticizer;
high-shear mixing.

Thus, the electrode composition slurry that is produced according to the present invention and the range of the electrode temperature treatment for the drying are fully acceptable for processing by conventional and commonly used coating machines.

The lithium primary and lithium-ion secondary batteries contains anodes with a negative tab; cathode with a positive tab, separator and electrolyte. The electrolyte contains the dissociated lithium salt and aprotonic non-aqueous organic solvent. In this case of primary lithium cells, Li-metal or Li—Al alloy with Al content (of up to 5%, for example) can be used as an active anode material. In the case the lithium-ion system, graphite, carbon based material, or other materials that are capable of intercalating/de-intercalating the Li ion can be utilized as an anode. MnO₂, CFₓ, FeS₂, LiMn₂O₄, LiCoO₂, LiNiO₂, LiCo₁₋ₓNiₓO₂ and other materials used in lithium or lithium-ion system can be used as active cathode materials.

Selgar polypropylene films or others providing similar properties can be used as the separator. One or several aprotic solvents such as 1,2-dimethoxy ethane, propylene carbonate, ethylene carbonate, DMC, DEC, 1,3-dioxolane, tetrahydrofuran, γ-butyrolacton and others can be used as the non-aqueous liquid component of the electrolyte. LiPF₆, LiAsF₆, LiClO₄, LiN(CF₃CF₂SO₂)₂ or LiN(CF₃SO₂)₂, or others can be used as a lithium salt.

### BRIEF DESCRIPTION OF THE DRAWINGS

Details of the construction and practice of the present invention are further illustrated in the drawings below, and by their associated legends and descriptions.

FIG. 1 shows the scheme for electrode production where the components and steps are as follows: 101 is the PVDF binder; 102 is DMAC; 103 are mixtures of carbon black and graphite or graphitized carbon black; 104 is the electrochemically active electrode material; 105 is PTFE binder; 106 is the dissolution process; 107 is the mixing process; 108 is the PVDF solution in organic solvent; 109 is a blend of powders; 110 is the process of blending; 111 is the process of homogenization; 112 is the process of electrode mass coating on the current collector; 113 is the process of drying the electrode mass coated on the current collector; 114 is the process of electrode tape calendaring; 115 is the process of shaping the electrode to conform to the battery design; 116 is the process of residual moisture and organic solvent removal.

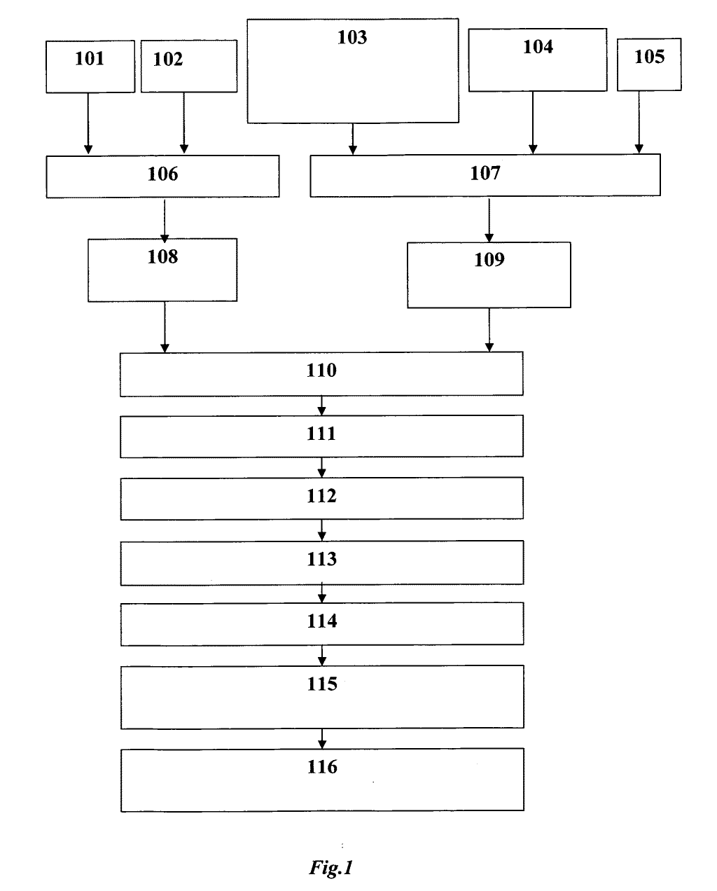

FIG. 2 shows the discharge characteristic of primary Li/MnO₂ prismatic cell at 50 mA at 23° C. Cathodes were produced in accordance with the present invention as in Example 1. Parameters of the cell are as follows. Dimension were 34 mm×60 mm×3.8 mm. Weight was 16 g. The package was laminated Al-foil. Parameters of the process: voltage range 3.3 to 1.5 V; operating temperature range: from minus 40 up to plus 65° C.; temperature range of battery storage; from minus 40 up to plus 70° C. Properties of the cell were: nominal capacity was 2 Ah at 50 mA to 1.5V at 23° C.; energy was 5.2 Wh at 50 mA to 1.5V at 23° C. Specific discharge capacity of MnO₂ achieved during discharge was 260-270 mAh/g. Specific energy of the battery was 325 Wh/kg.

FIG. 3 shows discharge curves of the MnO₂ cathodes. Discharge was for electrochemical cells with lithium anodes (1 cathode & 2 anodes). Cathodes were prepared according to the present invention as in Example 2. Size of the cathodes was 31 mm×54 mm with two-sided coating on an Al-grid. The coating density was 15 mg/cm². Electrolyte was PC, DME, TGF, 0.5 M LiClO₄. Parameters of the discharge are shown in Table 1 below.

TABLE 1
Discharge parameters for cells as described in Example 2.

| | | | Specific discharge |
|---|---|---|---|
| | Discharge current | | capacity of MnO₂, |
| Curve # | density, mA/cm² | Discharge current, C | mAh/g |
| 301 | 0.15 | 0.05 | 260 |
| 302 | 1.5 | 0.5 | 216 |
| 303 | 3.0 | 1.0 | 193 |
| 304 | 4.5 | 1.5 | 187 |
| 305 | 6.0 | 2.0 | 165 |
| 306 | 12.0 | 4.0 | 127 |

FIG. 4 shows the discharge curves of MnO₂ cathodes obtained in electrochemical cells with lithium anodes (two cathodes & three anodes) at a temperature of minus 40° C. Cathodes were produced according to the present invention as in Example 3. Dimension of the cathodes were 31 mm×54 mm. Coating was provided for both sides of the Al-foil. Coating density was 15 mg/cm². Electrolyte was PC, DME, TGF, 0.5 M LiClO₄. Discharge cycles were done according to the following diagram: in FIG. 4. 101 represents storage for one hour at minus 40° C. followed by discharge to a final voltage of 1.75 V. 102-108 represent storage for one hour at minus 40° C., followed by discharge for 10 min or to a final voltage of 1.75 V. Parameters of the discharge are presented in Table 2.

TABLE 2
Discharge parameters for cells as described in Example 3.

| | Discharge current | | Discharge capacity |
|---|---|---|---|
| cycle # | density, mA/cm² | Discharge current, mA | at a circle, mAh |
| 401 | 1.31 | 88 | 41.6 |
| 402 | 1.31 | 88 | 13.3 |
| 403 | 1.31 | 88 | 13.4 |
| 404 | 1.22 | 81.6 | 13.6 |
| 405 | 1.22 | 81.6 | 13.6 |
| 406 | 1.22 | 81.6 | 13.6 |
| 407 | 1.22 | 81.6 | 13.6 |
| 408 | 1.22 | 81.6 | 13.6 |

FIG. 5 shows the discharge curves of the CFₓ based cathodes obtained in electrochemical cells with lithium anodes (one cathode & two anodes). Cathodes were fabricated according to Example 4. Coating was provided on both sides of the Al-foil. Consistent with following parameters of the process 501, discharge current was 6 mA/cm², average discharge voltage was 2.23 V. Consistent with following parameters of the process 502 discharge current was 12 mA/cm². Average discharge voltage was 2.1 V.

FIG. 6 shows the discharge curves of LiMn₂O₄ based cathodes obtained in electrochemical cells with lithium anodes (one cathode & two anodes). Cathodes were prepared according to Example 5. Coating was provided for both sides of the Al-foil. The density of the cathode mass was 4.2 mg/cm². Parameters of the curves are presented in Table 3.

TABLE 3
Discharge parameters for cells as described in Example 5.

| | | | Specific discharge |
|---|---|---|---|
| Curve | Discharge current | | capacity of |
| # | density, mA/cm² | Discharge current, C | LiMn₂O₄, mAh/g |
| 601 | 0.24 | 0.5 | 111 |
| 602 | 0.53 | 1.1 | 108 |
| 603 | 2.65 | 5.5 | 97 |
| 604 | 5.30 | 10.9 | 91 |
| 605 | 7.60 | 15.8 | 84 |
| 606 | 10.0 | 20.6 | 76 |
| 607 | 12.4 | 25.5 | 69 |
| 608 | 14.7 | 30.4 | 61 |
| 609 | 17.7 | 36.5 | 51 |

### DETAILED DESCRIPTION OF THE INVENTION AND PREFERRED EMBODIMENTS

The invention can be practiced by the steps described below.

Step 1. Preparation of a powder-like blend of the electrode components including active electrode material, conductive additive in the form of graphitized carbon black with specific surface area from 40 up to 70 m²/g and 50% (material has a particle size up to 3 micron or the mix of carbon black and graphite in the ratio from 2:1 up to 1:1 by mass), PTFE powder with the particle sizes from 0.2 up to 4 μm. As a proportion of the total mass:
Active cathode material is 86-91%;
Graphitized carbon black or the mix of carbon black and graphite is 6-10%, and
PTFE is 3-4%.

Mixing of solid phase cathode materials is carried out using a ball mixer or the other suitable mixers designed for dry component mixing.

Step 2. Preparation of the solution of high-molecular weight PVDF or PVDF/HFP in dimethyl acetoamide in the following proportions of the total mass:
PVDF or PVDF/HFP: 2-4%;
DMAC: 96-98%.

PVDF or PVDF/HFP is dissolved using a paddle type mixer-emulsifier with moderate heating up to 60° C.

Step 3. The solid phase component blend is mixed with a dimethylacetoamide solution of PVDF or PVDF/HFP carried out by one of two methods:
The solid phase component blend is introduced into the dimethylacetoamide solution of PVDF or PVDF/HFP by 10% to 15% portions with continuous mixing using low-speed mixer with anchor or Z-type paddles¹;
The PVDF or PVDF/HFP solution is poured into the solid phase component blend with continuous mixing using low-speed mixer with anchor or Z-type paddles.

The mass ratio between solid phase component blend and dimethylacetoamide solution of PVDF or PVDF/HFP is as follows:
Solid-phase component blend is 30% to 60%.
Dimethylacetoamide solution of PVDF or PVDF/HFP is 70% to 40%.

Step 4. Homogenization of slurry using three types of mixing:
Agitation by low-speed mixer with anchor or Z-type paddles (Three Wing Anchor Agitator) at 20-40 revolutions per minute;
Stirring with a paddle type mixer-emulsifier (High Speed Disperser) at 200-300 revolutions per minute;
Dispersion with a high-shear mixer (High Shear Rotor/Stator Mixer) gradually increasing from 1500 to 8000 revolutions per minute;

Homogenization is carried out for 30-45 minutes with continuous cooling.

Step 5. The homogenized slurry is degassed by applying moderate vacuum (10-50 mmHg) while constant agitating using a low-speed mixer with anchor or Z-type paddles (ROSS Model VMC-100 VACUUM MIXER or equivalent).

Step 6. The electrode active material, in the form of a slurry, is coated² on one or both sides of the current collector in the form of a foil or grid (preferable aluminum) by extrusion using extruder heads with variable slurry distribution through slots with fixed gaps. The coated foil or grid (preferable aluminum) moves through two drying zones and is dried by heated air blow at 80° C. and 120° C., respectively. The tape advances at a speed of about 0.5 to 1.0 meters per minute.

Step 7. The electrode tape is then subjected to a calendaring process that gradually reduces the coating thickness by up to 20-25%.

Step 8. The electrodes are shaped to conform to the design of the battery in which they will be used.

Step 9. Final drying of the electrodes is accomplished by one of three methods:
at 125° C. to 170° C. under air re-circulated through the system that removes residual moisture and organic solvent vapor;
at 125° C. to 170° C. under inert gas re-circulated through a system that removes residual moisture and organic solvent vapor;
at 125° C. to 170° C. under vacuum.

### EXAMPLES OF PREFERRED EMBODIMENTS

Described below are examples illustrating the use and application of the present invention. These application examples and results are for illustration purposes only, and in no way limit the intended scope of applications of the invention.

### Example 1

This Example is connected with cathode based on MnO₂ as the active material. Cathode was produced by the method according invention.

Content of electrochemically active composition slurry are as follows:
PVDF—homopolymer (Solef® 6020, Solvay): 2.0%
PTFE, (Zonyl® MP 1100, DuPont): 1.5%
MnO₂ (CDM): 43.5%
Graphite (ABG1005, Superior Graphite Co.): 1.0%
Carbon black (Acetylene black AB55, Chevron Phillips Chemical Co.): 2.0%
N,N-Dimethylacetamide (OMNISOLV): 50%

A blend of solid-phase components of MnO₂, carbon black, graphite and PTFE was prepared by mixing for 5-6 hours using a ball-mixer.

An N,N-Dimethylacetamide solution of PVDF was made by using Lab mixer with a DL-attachment at 250 rpm for 3 hours with moderate heating up to 60° C.

A slurry of the electrochemically active composition was prepared in three stages using a VACUUM MIXER as follows:
Mixing the PVDF solution with the solid-phase component blend. A Three Wing Anchor Agitator was used for mixing for 30 minutes at 20-40 rpm.
Homogenization by carried out using a Wing Anchor Agitator at 20-40 rpm, a High Speed Disperser at 200-300 rpm and a High Shear Rotor/Stator Mixer while gradually the speed from 1500 to 8000 rpm. Mixing was for 30-45 minutes with continuous cooling.
Degassing was carried out for 30 minutes under moderate vacuum. A Three Wing Anchor Agitator was used at 20-40 rpm.

The resulting slurry was applied to both sides of a 35 micron thick aluminum grid using a COATING MACHINE. The speed of the tape was 1 meter per minute. The tape then passed passing through dryers at 80° C. and 120° C.

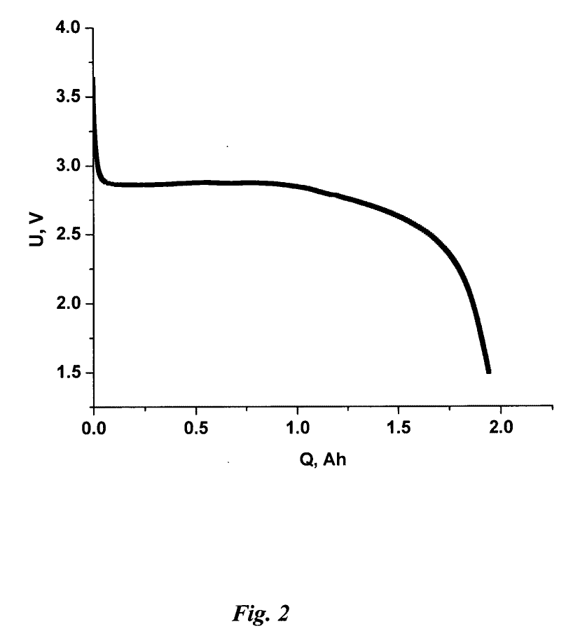

The resulting cathodes were utilized in prismatic battery assembly consisting of 10 cathodes and 11 Li-anodes. The overall battery dimension was 34 mm×60 mm×3.8 mm. The weight was 16 g. Cathode mass density was 2.7 g/cm³ to 2.8 g/cm³. The electrolyte was PC, DME, TGF and 0.5 M LiClO₄ The battery was discharged with a 50 mA current. MnO₂ specific capacity was determined to be 270 mAh/g, The specific energy was 730 mWh/g. Discharge characteristics of the battery are shown in FIG. 2.

The results shown here confirm the high discharge capacity of the electrode and high energy of the cells based on the electrodes that were produced according to the present invention. The resulting cells have excellent properties at operating temperature ranging from minus 40 up to plus 65° C. and a battery storage temperature ranging from minus 40° C. up to plus 70° C.

### Example 2

This Example is a cathode based on MnO₂ as the active material. The cathode was produced by the method of the present invention.

The electrochemically active slurry composition was composed as follows:
PVDF—homopolymer (Solef® 6020, Solvay): 2.0%
PTFE, (Zonyl® MP 1100, DuPont): 1.5%
MnO₂ (CDM): 42.5%
Graphitized carbon black (SCD 315, Superior Graphite Co.): 4.0%
N,N-Dimethylacetamide (OMNISOLV) solvent: 50%

Blending of the solid-phase components of MnO₂, graphitized carbon black, and PTFE was prepared by mixing for 5-6 hours using a ball-mixer.

An N,N-Dimethylacetamide solution of PVDF was produced by using a Lab mixer with DL-attachment at 250 rpm for 3 hours with moderate heating up to 60° C.

A slurry of the electrochemically active composition was prepared in three stages using a VACUUM MIXER:
The PVDF solution and solid-phase component blend were mixed. A Three Wing Anchor Agitator was used for mixing for 30 minutes at 20 to 40 rpm. Homogenization was carried out using a Wing Anchor Agitator at 20-40 rpm, a High Speed Disperser at 200-300 rpm, and a High Shear Rotor/Stator Mixer while gradually increasing mixing speed from 1500 to 8000 rpm. Mixing was carried out for 30-45 minutes with continuous cooling.
Degassing was carried out for 30 minutes under moderate vacuum. A Three Wing Anchor Agitator was used at 20-40 rpm.

The slurry was applied to both sides of a 35 micron thick current collector composed of an aluminum grid using COATING MACHINE. The tape was advanced at a speed of 1 meter per minute and it passed sequentially through drying zones at 80° C. and 120° C.

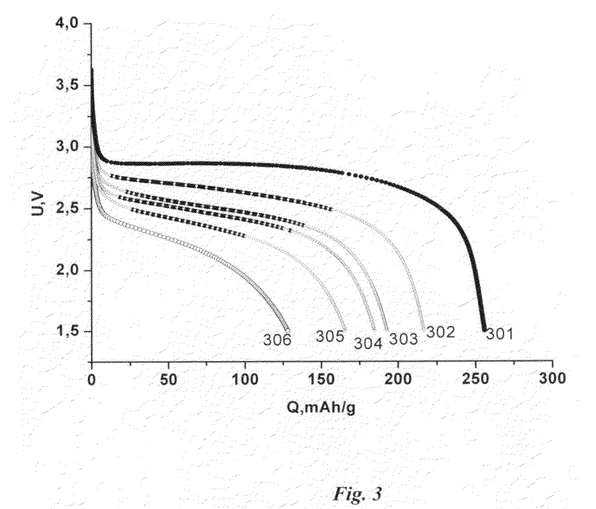

The resulting cathodes were utilized to assemble a prismatic electrochemical cell consisting of 1 cathode and 2 Li-anodes. The electrolyte was composed of PC, DME, TGF, and 0.5 M LiClO₄. The cells were discharged at room temperature at current densities ranging from 0.15 mA/cm² up to 12 mA/cm². This corresponded to the charge currents from 0.05 up to 4.0 C. Discharge characteristics are shown in FIG. 3.

Results from testing of the lithium primary cells with cathodes produced according to the present invention confirm the high efficiency of the discharge process over a wide operating range of discharge currents up to 12 mA/cm².

### Example 3

This Example describes fabrication of a cathode based on MnO₂ as the active material. The cathode was produced by the method of the present invention.

The contents of electrochemically active composition slurry are as follows:
PVDF—homopolymer (Solef® 6020, Solvay): 2.0%
PTFE, (Zonyl® MP 1100, DuPont): 1.5%
MnO₂ (CDM): 42.5%
Graphitized carbon black (SCD 315, Superior Graphite Co.): 4.0%
N,N-Dimethylacetamide (OMNISOLV): 50%

Blending of the solid-phase components MnO₂, graphitized carbon black and PTFE was carried out by mixing for 5-6 hours using a ball mill.

An N,N-Dimethylacetamide solution of PVDF was prepared using the Lab mixer with DL-attachment at 250 rpm for 1 hour with moderate heating up to 60° C. The slurry of the electrochemically active composition was prepared using a Lab mixer with an L-high-shear attachment with 8000 rpm for three 10-minute steps followed by periodic cooling. The slurry was applied to both sides of a 50 micron thick aluminum foil using a Lab coating machine.

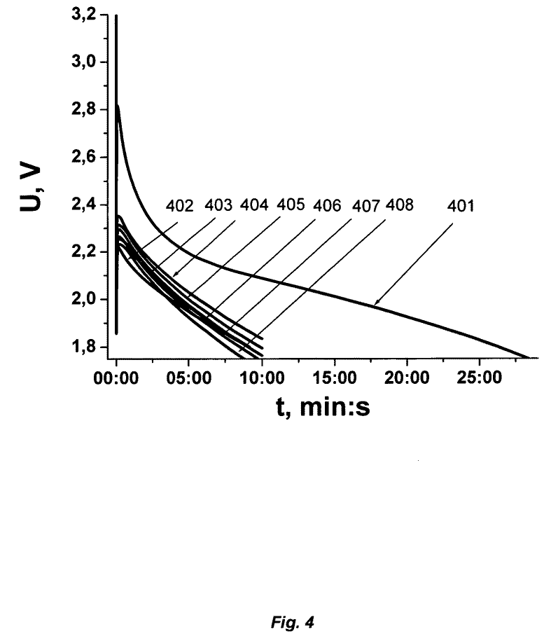

The resulting cathodes were utilized to assemble prismatic electrochemical cells consisting of 2 cathodes and 3 anodes, based on an Li—Al alloy. The electrolyte was PC, DME, TGF, and 0.5 M LiClO₄. The cell was discharged at 1.31 mA/cm² and 1.22 mA/cm² currents at minus 40° C. to a voltage of 1.75 V. Discharge characteristics of the cell are shown in FIG. 4.

Results from testing of the cells with cathodes produced according to the present invention show high efficiency of the cell at low temperatures of minus 40° C., even after prior battery storage at low temperature of minus 40° C. This type of the cell could be used for emergency purposes after long term storage at low temperatures.

### Example 4

This Example is a cathode based on CFx as the active material. The cathode was produced by the method of the present invention.

Content of electrochemically active composition slurry are as follows:
PVDF—homopolymer (Solef® 6020, Solvay): 1.4%
PTFE, (Zonyl® MP 1100, DuPont): 1.0%
CFₓ (ARS): 27.6%
Graphitized carbon black (SCD 315, Superior Graphite Co.): 3.3%
N,N-Dimethylacetamide (OMNISOLV) solvent: 66.7%

Blending of solid-phase components CFₓ, graphitized carbon black and PTFE was carried out by mixing for 5-6 hours using a ball-mill. A PVDF solution in N,N-Dimethylacetamide was prepared using a Lab mixer with DL-attachment at 250 rpm for 1 hour with moderate heating up to 60° C. the slurry of an electrochemically active composition was prepared using a Lab mixer with L-high-shear attachment at 8000 rpm in three stages. Each was carried out for 10 minutes with periodical cooling. The slurry was applied to both sides of a 20 micron thickness aluminum foil using a Lab coating machine.

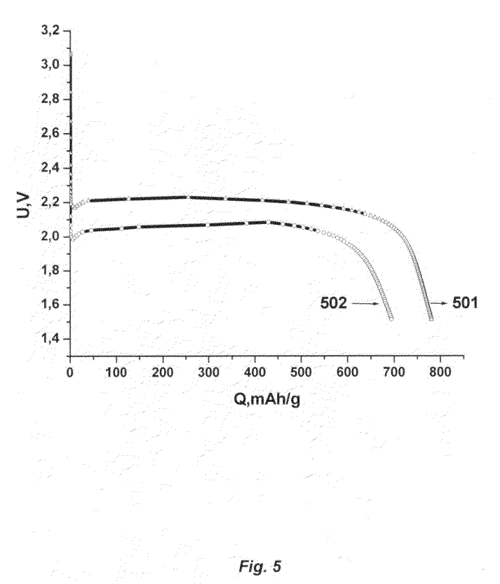

The resulting cathodes were utilized for assembling an electrochemical cell of prismatic design consisting of 1 cathode and 2 Li-anodes. The electrolyte was PC, DME, TGF, and 0.5 M LiClO₄. The cell was discharged at current densities of 6 mA/cm² (discharge voltage 2.23 V) and 12 mA/cm² (discharge voltage 2.10 V) at room temperature. Cell discharge characteristics are presented in FIG. 5.

Results of testing confirmed the high efficiency of the cathode based on CFx that was produced according to the present invention. The cathode has a high discharge capacity at high discharge currents of up to 12 mA/cm without any voltage delay.

### Example 5

This Example is describes a cathode based on LiMn₂O₄-spinel as the active material. The cathode was produced by the method of the present invention.

The composition of the electrochemically active slurry was as follows:
PVDF/HFP—copolymer (Solef® 21216, Solvay): 1.4%
PTFE, (Zonyl® MP 1100, DuPont): 1.0%
LiMn₂O₄-spinel: 27.6%
Graphitized carbon black (SCD 315, Superior Graphite Co.): 3.3%
N,N-Dimethylacetamide (OMNISOLV) solvent: 66.7%

Blending of the solid-phase component manganese spinel, graphitized carbon black and PTFE was carried out by mixing for 5-6 hours using a ball-mill. An N,N-Dimethylacetamide solution of PVDF was prepared using a Lab mixer with DL-attachment at 250 rpm for 1 hour with moderate heating up to 60° C. A slurry of electrochemically active composition was prepared using a Lab mixer with L-high-shear attachment at 8000 rpm in three stages, each with a duration of 10 minutes with periodic cooling. The resulting slurry was applied to both sides of a 20 micron thick aluminum foil using a Lab coating machine.

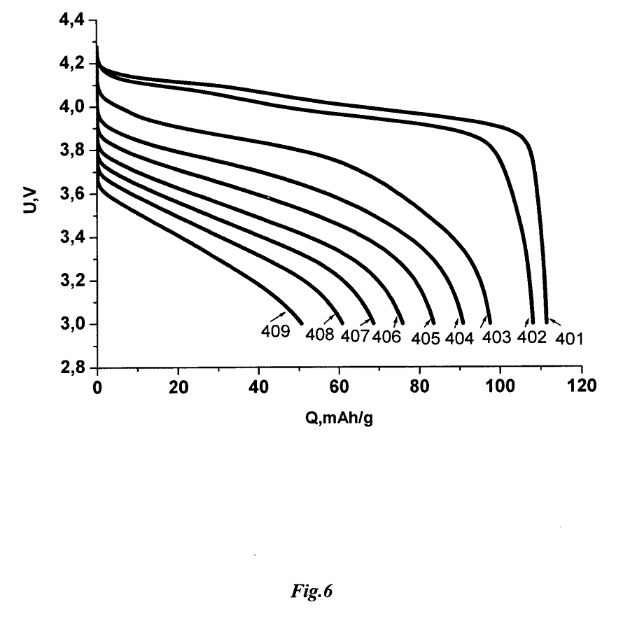

The resulting cathodes were utilized for assembling prismatic electrochemical cells consisting of 1 cathode and 2 Li-anodes. The electrolyte was EC, DMC, and 1.0 M LiClO₄. The cells were discharged at current densities ranging from 0.24 up to 17.7 mA/cm², corresponding to discharge currents of from 0.5 C to 36.5 C. Discharge characteristics are shown in FIG. 6.

Results of testing of the batteries with cathodes based on LiMn₂O₄-spinel produced according to the present invention confirm the high level of the cathode efficiency even at a high rate of discharge (36.5 C).

### CLOSURE

While various embodiments of the present invention have been shown and described, it will be apparent to those skilled in the art that many changes and modifications may be made without departing from the invention in its broader aspects.

We claim:

1. Electrode for lithium primary and secondary batteries and supercapacitors, consisting of a metal current collector coated by an electrochemically active composition, comprising active material, conductive additive having electron conductivity, and two binders, one of which is soluble in organic solvent during preparation of the electrochemically active composition slurry, and one of which is insoluble in organic solvent and is introduced into said slurry during the process of initial mixing of the dry components.

2. Electrode as in claim 1 wherein the active material is comprised of one or more of an oxide, sulphides, lithiated oxides, metal complexes, spinels, fluorinated carbon, carbon, or compounds based on carbon.

3. Electrode as in claim 1 wherein the conductive additive with electron conductivity is a blend of carbon black and graphite in the ratio from 2:1 to 1:1 by mass.

4. Electrode as in claim 1 wherein one of the conductive additives with electron conductivity is a carbon material made of graphitized carbon black with specific surface area ranging from 40 m²/g to 70 m²/g and 50% of the graphitized carbon black has a particle size of up to 3 microns.

5. Electrode as in claim 1 wherein a PVDF class compound is the binder soluble in organic solvent during preparation of the electrochemically active composition and wherein the PVDF is copolymer or homopolymer with a molecular weight of at least 3×10⁵ amu.

6. Electrode as in claim 1 wherein a PTFE-based compound is the binder that is insoluble in the electrochemically active slurry composition.

7. Electrode as in claim 6 wherein a PTFE class binder is in the form of a powder with the particle size of 0.2 to 4 microns.

8. Electrode as in claim 1 wherein the mass ratio of PVDF to PTFE ranges from 1.2:1 to 1.7:1 in the solid phase of the electrochemically active composition.

9. Production method of the electrode for primary and secondary lithium batteries and capacitor comprising the steps of preparation of a blend of solid-phase components of electrochemically active composition includes mixing the powers of the active material, the conductive additives with electron conductivity and the powder of the binder from the PTFE class that is insoluble in organic solvent, dissolution of soluble binder from the group of PVDF in a suitable organic solvent; combination and homogenization of solid-phase components mixture and solution of dissolved binder; slurry degassing; coating of current collector; drying of the coated mass; compressing by calendering; removing the residual amount of water and solvent.

10. Method as in claim 9 wherein the soluble binder solution consists of PVDF dissolved in an appropriate solvent selected from the group of N-methyl-2-pyrrolidone, acetone, dimethylformamide, dimethylacetoamide (mainly dimethylacetoamide) with mild heating up to 60° C.

11. Method as in claim 9 wherein the blend of the solid phase components is introduced into the solution of the soluble binder by the 10% to 15% portions of the total amount of the dry components.

12. Method as in claim 11 wherein the low-speed mixer with anchor or Z-type paddles is used during introduction of solid phase components mixture into the of soluble binder solution.

13. Method as in claim 9 wherein the solution of the soluble binder is introduced into the blend of the solid phase components with continuous mixing using the low-speed mixer anchor or the Z-type paddles.

14. Method as in claim 9 wherein the product of mixing the solid phase component blend and soluble binder solution is subjected to homogenization using rotor type high-speed mixer wherein the rotational speed is gradually increased from 1500 up to 8000 rpm over a period of 30-45 minutes while the mixture is cooled.

15. Method as in claim 9 wherein the homogenized slurry of the electrochemically active composition is subjected to degassing by vacuum during continuous mixing using a low-speed mixer anchor or Z-type paddles.

16. Method as in claim 9 wherein the proportion of solid phase components in slurry is 30% to 60% by mass.

17. Method as in claim 9 wherein slurry viscosity ranges from 5000 to 12000 cp at 23° C. measured by Brookfield DV III, 20 rpm, spindle #31

18. Method as in claim 9 wherein the electrochemically active composition is dried immediately after coating onto the current collector by gradually increasing the temperature from 80° C. up to 120° C. with removal of solvent vapors by purging with hot air.

19. Method as in claim 9 wherein the dried coating of electrochemically active composition on a current collector is compressed by calendaring by which the thickness is gradually reduced by 20% to 25% as compared to initial the thickness, and whereby the electrode mass density is increased by 30-45% and final porosity of the coating is 20% to 40%.

20. Method as in claim 9 wherein the cut-to-element dimensions electrode is dried at a temperature of 125° C. to 170° C. in air or inert gas that is re-circulated through a system that removes residual moisture and organic solvent vapor, or under vacuum.
